(19) United States
(12) Patent Application Publication
(10) Pub. No.: US 2013/0140205 A1
(43) Pub. Date: Jun. 6, 2013

(54) STAPLE CARTRIDGE

(71) Applicant: Arne Edvardsson, Hestra (SE)

(72) Inventor: Arne Edvardsson, Hestra (SE)

(21) Appl. No.: 13/641,127

(22) PCT Filed: Mar. 2, 2011
(86) PCT No.: PCT/SE11/00041

§ 371 Date: Feb. 25, 2013

(30) Foreign Application Priority Data
Apr. 14, 2010 (SE) 1050365-4

(51) Int. Cl. B25C 5/16

(52) U.S. Cl. CPC B25C 5/1686
USPC 206/338

(57) ABSTRACT

A staple cartridge (7) containing staple blanks (8) which is intended to be releasably mounted to an electrically driven stapler (1), whose motor (10) is included in an electric current circuit (19) and is driven by this current circuit. In addition, a part of the current circuit (19) is disposed to the staple cartridge (7).

### TECHNICAL FIELD

The present invention relates to a staple cartridge containing staple blanks, the cartridge being intended to be removably mounted in an electrically driven stapler whose motor forms part of an electric power circuit and is driven by this power circuit.

The present invention also relates to a stapler which is adapted to cooperate with the staple cartridge according to the present invention.

### BACKGROUND ART

Staple cartridges adapted to be removably mounted in an electrically driven stapler are common in the art. To name but a few of them, it might be mentioned that such staplers and cartridges are disclosed in the Applicant's own Patent Specifications EP 0 636 058, EP 0 636 059 and WO 2006/036098.

A feature common to these prior art staple cartridges is that the staplers to which they are intended to be mounted carry out a commanded stapling stroke regardless of whether there is a staple cartridge in the stapler or not, or whether or not the staple cartridge is empty. In addition, the stapling stroke is carried out regardless of whether the cartridge is loaded with staples for thick or thin sheaves. This entails that, when the stapling stroke is carried out with an empty staple cartridge or without any staple cartridge being loaded in the stapler, no stapling will take place and the work carried out by the stapler will thus be unnecessary. The stapler carries out what is known as an empty stroke.

When the staple cartridge contains staples intended for thin sheaves, no satisfactory stapling will be achieved if the intention is to staple a thicker sheaf Nor will the stapling be satisfactory if staples for thick sheaves are used when thinner sheaves are being stapled. Further, because the stapling stroke is carried out regardless of the type of staple which is contained in the cartridge, each stapling stroke will be carried out on the assumption that the cartridge is loaded with staples which require the most energy. Apart from this entailing unnecessary energy consumption, an increased noise level is also created which may be disagreeable when a plurality of staplers are placed in the same room and run at the same time. In addition, this circumstance also entails that the stapler proper is exposed to unnecessary wear.

Moreover, these prior art cartridges provide no information as to how many staples are left at any given time in the cartridge. This may result in sheaves remaining unstapled because the cartridge is empty when stapling is ordered or that a series of staplings which is larger than the number of staples remaining in the cartridge is ordered. In addition, there is a risk that the user does not order a new cartridge in time when necessary.

U.S. Pat. No. 6,715,654 describes a staple cartridge which is provided with means which, in cooperation with the stapler in which it is mounted, make it possible for the user to ascertain the size of the staples loaded in the cartridge. In addition, information is provided as to whether the cartridge contains staples or is empty. The property of being able to ascertain the staple size loaded in the cartridge affords the advantage that it is possible to know what thickness of sheaves can be stapled without difficulty and, as will readily be perceived, the advantage of being able to ascertain that the cartridge is empty is that no empty stroke stapling needs to take place. However, this patent specification is silent as to whether these parameters are used to prevent stapling with an empty stapler from being carried out, i.e. the stapler carries out an empty stroke.

U.S. Pat. No. 6,474,633 discloses a cartridge which is provided with means which cooperate with means in the stapler in such a manner that it is possible to ascertain the size of the staples loaded in the cartridge. Nor does this patent specification provide any indication as to whether the stapling stroke is prevented if the incorrect staple size is employed, or whether the cartridge is empty, but the knowledge of staple size is used only to adapt the stapler for stapling of the intended sheaves.

JP 2002-196135 discloses a stapler which is provided with detector means which detect how many staples are left in the cartridge. These means comprise a part which is disposed in the cartridge which is read off by a device disposed outside the cartridge. However, this reading is extremely inaccurate and the value measured is only used in such a manner that it is possible for the user to be able to estimate how many staples are left in the cartridge.

U.S. Pat. No. 4,978,045 discloses a stapler which has a sensor device disposed outside the cartridge which registers the contents of the cartridge in such a manner that, when its contents are largely consumed, this is registered on a display which may be read off by the user of the stapler. However, this invention is such that the read-off only provides information to the effect that the store of staples in the cartridge is more or less consumed, for which reason no read-off of values for controlling the stapler apart from the fact that the cartridge is empty is obtained. Given that the read-off device is positioned on the outside of the cartridge, this will be sensitive to disturbance, for which reason the values which are read off may be unreliable.

Features common to these prior art cartridges are, however, that they either lack devices which prevent empty stroke stapling, or that they are provided with means which provide only limited information on the contents of the cartridge, or that values read off will, because of the design and construction of the cartridges, be extremely unreliable.

### OBJECTS OF THE INVENTION

There is thus a need in the art to realise a cartridge which displays such a design and construction that it provides reliable information about its contents in such a manner that empty stroke stapling is prevented, and which reliably provides information about the contents of the cartridge for controlling the stapling stroke of the stapler and for use of the stapler proper.

There is also need in the art to realise a stapler which is adapted to be able to be used in cooperation with such a cartridge.

### BRIEF DESCRIPTION OF THE INVENTION

The present invention thus provides a staple cartridge which displays the above-disclosed properties with a staple cartridge of the type disclosed by way of introduction which is characterised in that a part of the electric power circuit is connected to the staple cartridge.

Further, the present invention is characterised in that the part of the power supply circuit which is connected to the staple cartridge includes means which may store information as to the contents of the staple cartridge.

The present invention is further characterised in that said means comprise a memory circuit.

The present invention is also characterised in that said information includes information as to the size of staples loaded in the cartridge.

The present invention is yet further characterised in that the information includes information as to the number of staples originally loaded in the cartridge.

The present invention is yet further characterised in that the information includes the number of staples remaining in the cartridge.

The present invention is still further characterised in that the current circuit displays a drive circuit and a control circuit.

Moreover, the present invention realises a stapler which displays a power circuit which is closed with the power circuit connected to the staple cartridge. DR

### BRIEF DESCRIPTION OF THE ACCOMPANYING DRAWINGS

The present invention will now be described in greater detail hereinbelow, with reference to the accompanying Drawings. In the accompanying Drawings:

FIG. 1 is a schematic view of a stapler with a mounted cartridge according to the present invention;

FIG. 2 is a view illustrating a staple cartridge according to the present invention; and

FIG. 3 is a view illustrating an alternative embodiment of the current circuit included in the stapler.

### DESCRIPTION OF PREFERRED EMBODIMENT

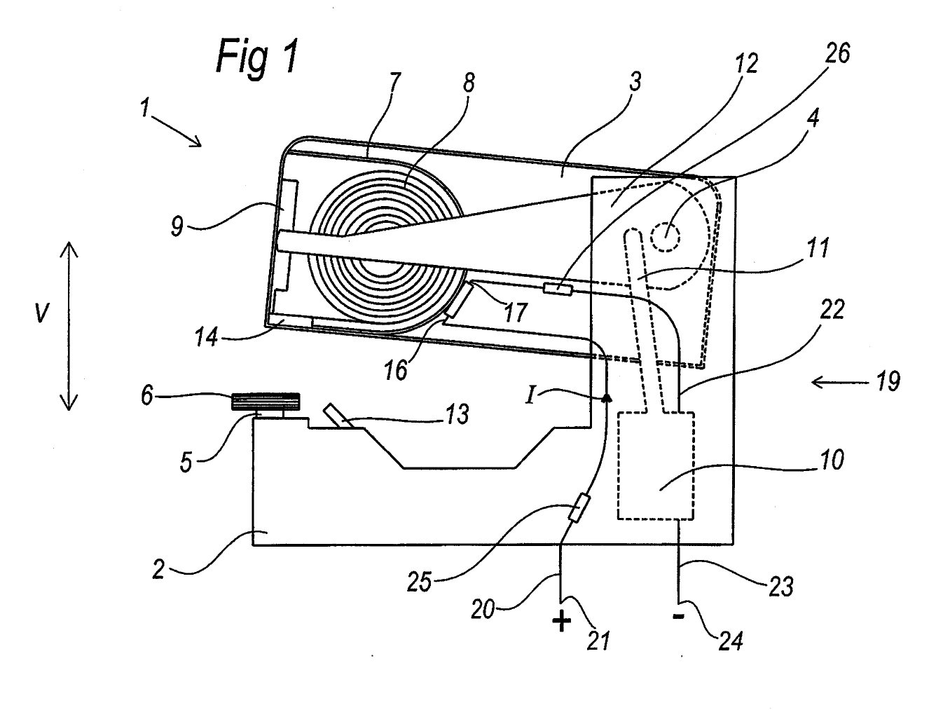

FIG. 1 is a highly schematic view of a stapler 1 which encompasses the present invention. It will be apparent from the figure that the stapler comprises a base section 2 and a stapler section 3 which are pivotably connected to a pivot shaft 4. The base section 2 and the stapler section 3 may be moved reciprocally in relation to one another about the pivot shaft 4 in the stapling movement which is indicated by the double-headed arrow V. An anvil 5 is disposed on the base section 2 on which the workpiece 6 which is to be stapled is placed. A staple cartridge 7 is provided for the stapler section 3 and in which staples 8 are loaded in reel form and to which is connected a driver 9. In a manner per se known to a person skilled in the art, the staple cartridge is removably mounted on the stapler, for which reason their interconnection will not be described in greater detail herein. An electrically driven motor 10 is positioned in the base section 2 which, across an interjacent linkage 11, is connected to a drive arm 12 which is also pivotably journalled to the pivot shaft 4 and, in its opposing end, connected to the driver 9. A feeder device 13 is disposed at the base section 2 and which, in a manner which will be described in greater detail hereinbelow, advances the reel of staples 8 through an aperture 14 in the staple cartridge 7.

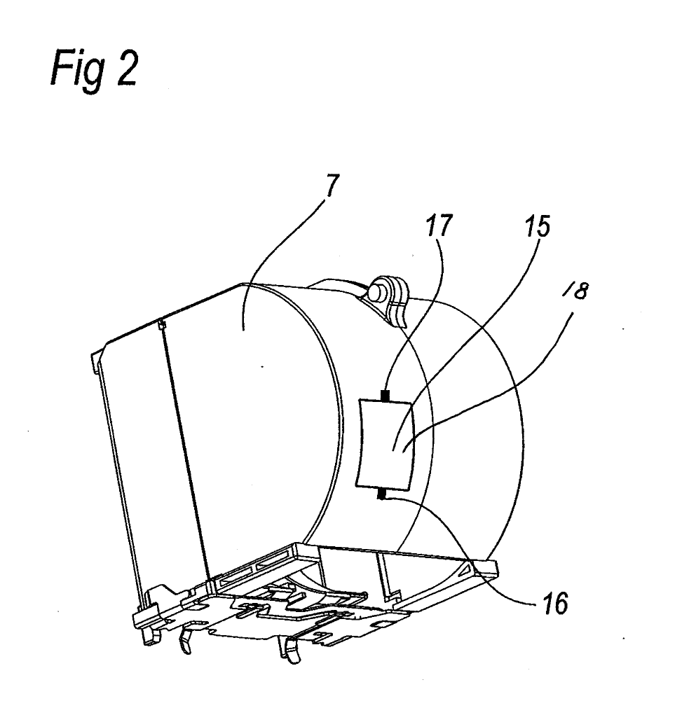

FIG. 2 shows the staple cartridge 7 in detail. A device 15 is disposed at the cartridge and is provided with first and second electric connecting means 16 and 17, respectively. The device 15 forms a current circuit section 18 of the current circuit arrangement which will be described below.

The current supply arrangement 19 is apparent from FIG. 1 and comprises a first conductor section 20 which extends between a positive pole 21 and the connecting means 16 on the cartridge 7. The current circuit thereafter runs through the device 15 which forms the current circuit section 18 and through the second connecting means 17 to a second conductor 22 which is connected to the motor 10. From the motor 10 runs a third conductor section 23 which is connected to a negative pole 24. On the first conductor section 20 there is disposed a switch 25 and on the second conductor section there is disposed a display unit 26.

The stapler 1 operates such that when the switch 25, in a per se known manner, closes the current circuit 19, the current I runs through the conductor 20 to the connecting means 16 and further through the device 15 whereafter it runs over the second connecting means 17 through the conductor 22 to the motor 10 and thereafter through the motor to the conductor 23 and further to the negative pole 24.

When the current I runs through the motor, the motor 10, via the linkage 11, drives the drive arm 12 whereby the base section 2 and the stapler unit 3 are moved towards one another into contact with the workpiece 6. Thereafter, the drive arm 12 drives the driver 9 further in a direction towards the base section 2 whereby a staple is driven into the workpiece 6, whereby stapling of the workpiece is realised in a per se known manner. During this sequence, the feeder device 13 cooperates with the staple reel 8 and advancement of staples takes place to a position in which the driver 9 operates.

Thereafter, the motor continues to drive the base section and the staple unit in an opposing direction from one another to the position which is illustrated in FIG. 1, and the stapler has thereby executed one stapling operation and is placed in position to carry out a new stapling operation.

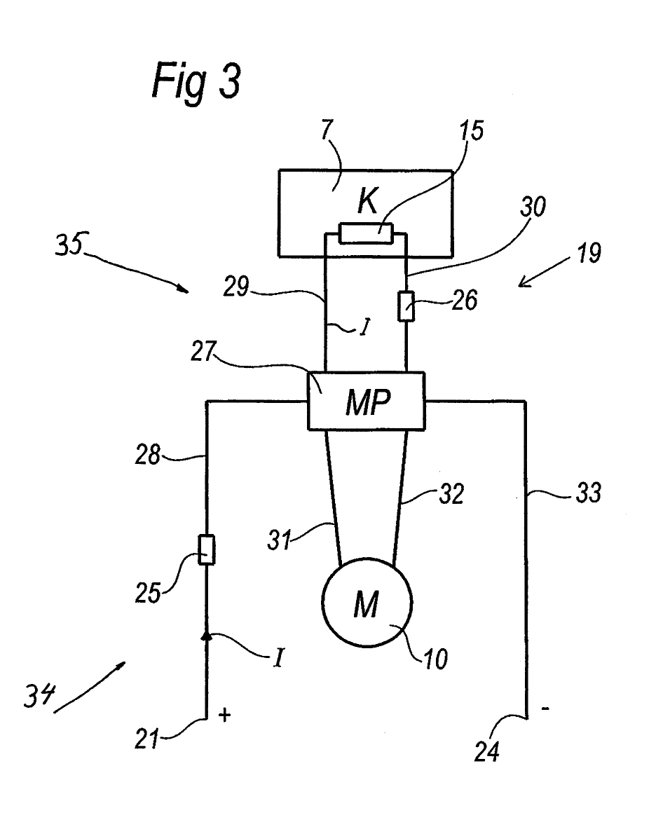

FIG. 3 shows an alternative embodiment of the current circuit arrangement 19. In this alternative arrangement, a microprocessor 27 is included. A conductor 28 is connected to the microprocessor from the positive pole 21. A conductor 29 is connected from the microprocessor and leads to the device 15 disposed on the cartridge, and from the device 15, a conductor 30 returns to the microprocessor 27. From the microprocessor, a conductor 31 leads to the motor 10 and from the motor 10 a further conductor 32 runs to the microprocessor. Finally, a conductor 33 runs from the microprocessor to the negative pole 24. In this arrangement, the current I runs so that, from the positive pole 21, the current runs through the conductor 28 to the microprocessor 27. From the microprocessor, the current runs further through the conductor 29 to the device 15 disposed on the cartridge. From this device, the current runs back to the microprocessor 27 over the conductor 30. Depending upon the type of signal emitted by the device 15 to the microprocessor 27, the microprocessor further transmits a current through the conductor 31 to the motor 10 for operation of the motor, and through the conductor 32 the current thereafter continues to the microprocessor 27 and thence over the conductor 33 to the negative pole 24. Thus, this current circuit arrangement encompasses a drive circuit arrangement 34, and a control circuit arrangement 35. The current I in the drive circuit 34 runs from the pole 21 through the conductor 28 with associated switch 25, the microprocessor 27, the conductor 31, the motor 10, the conductor 32, the microprocessor 27, the conductor 33 to the pole 24. The current I in the control circuit 35 runs from the microprocessor 27, through the conductor 29, through the device 15, through the conductor 30 with associated display 26, to the microprocessor 27.

The device 15 may consist of a per se known electric element such as a memory circuit which, in a per se known manner, may contain information about the size of staple which is loaded in the cartridge, how many staples there are in the cartridge at any given time or whether the cartridge is empty. This information may, in a per se known manner, be processed in the microprocessor and the microprocessor may emit a current to the motor which is adapted in relation to the contents of the cartridge.

In that the device 15 through which the current I runs is positioned on the cartridge, it will be ensured that the stapler cannot be started if there is no staple cartridge mounted in the stapler. Moreover, since the device 15 is positioned on the cartridge, it will be ensured that the sensing of the contents of the cartridge transmitted to the device 15 will be extremely reliable and precise and not subject to external disturbances.

The display 26 disposed on the conductor 22 consists of a display of per se known type which may digitally display and convey to the user of the stapler information concerning the contents of the cartridge and thereby also provide the user with information about how the stapler may be employed.

As will be apparent from the foregoing description, the stapler 1 displays a current circuit arrangement 19 which partly runs through the staple cartridge and is closed when the staple cartridge is fitted to the stapler, which entails that if there is no cartridge in position in the stapler, no stapling will take place.

The present invention is not restricted by the foregoing description, but is restricted only by the scope of the appended claims.

1. A staple cartridge containing staple blanks which is intended to be releasably mounted to an electrically driven stapler whose motor is included in an electric current circuit and is driven by this current circuit, characterised in that a current circuit section of the current circuit is disposed to the staple cartridge.

2. The staple cartridge as claimed in claim 1, characterised in that the current circuit section includes a device which is rehearsed to store information on the contents of the cartridge.

3. The staple cartridge as claimed in claim 2, characterised in that the device is a memory circuit.

4. The staple cartridge as claimed in claim 2, characterised in that said information comprises information as to the size of staples loaded in the cartridge.

5. The staple cartridge as claimed in claim 2, characterised in that said information comprises information as to the number of staples originally loaded in the cartridge.

6. The staple cartridge as claimed in claim 2, characterised in that said information comprises information as to the number of staples remaining in the cartridge.

7. The staple cartridge as claimed claim 1, characterised in that the current circuit comprises a drive circuit and a control circuit.

8. A stapler which includes a releasable staple cartridge and an electric motor which is driven by a current circuit, characterised in that the current circuit is closed by a current circuit section disposed to the staple cartridge.

9. The staple cartridge as claimed claim 2, characterised in that the current circuit comprises a drive circuit and a control circuit.

10. The staple cartridge as claimed claim 3, characterised in that the current circuit comprises a drive circuit and a control circuit.

11. The staple cartridge as claimed claim 4, characterised in that the current circuit comprises a drive circuit and a control circuit.

12. The staple cartridge as claimed claim 5, characterised in that the current circuit comprises a drive circuit and a control circuit.

13. The staple cartridge as claimed claim 6, characterised in that the current circuit comprises a drive circuit and a control circuit.
